(19) United States
(12) Patent Application Publication
(10) Pub. No.: US 2014/0118468 A1
(43) Pub. Date: May 1, 2014

(54) METHOD AND SYSTEM FOR ADAPTING A TELEVISION FOR MULTIMEDIA CONFERENCING

(71) Applicant: Rekinnect, Inc., Toronto (CA)

(72) Inventors: Thomas Gordon PURDY, Toronto (CA); Thomas PIRNER, Minden (CA)

(73) Assignee: Rekinnect, Inc., Toronto (CA)

(21) Appl. No.: 14/063,392

(22) Filed: Oct. 25, 2013

Related U.S. Application Data
(60) Provisional application No. 61/718,398, filed on Oct. 25, 2012.

(51) Int. Cl. H04N 7/15

(52) U.S. Cl. CPC H04N 7/15
USPC 348/14.08

(57) ABSTRACT

A system which provides “hands-off” accommodation of an elderly, technically-challenged and/or disabled user, enabling them to stay well-connected through “virtual visits” with friends and family members. Such “virtual visits” duplicate the rich shared experience of a personal visit, through multimedia conferencing and synchronized sharing of digital media, including personal photos, home videos, or other types of digital media. The “hands-off” capability is enabled through a controller which can be installed in laptops or computer-based devices, which interacts over the Internet with a player installed for the elderly, technically-challenged and/or disabled user. The controller user interface provides controller users with the means to easily initiate, control and synchronize a “virtual visit” with the player user via the Internet, and remotely control the operation of the player, as well as the player user's television and other home entertainment devices.

### RELATED DOCUMENTS

This application claims priority from U.S. provisional patent application No. 61/718,398 filed on Oct. 25, 2012 the entirety of which is incorporated by reference herein.

### TECHNICAL FIELD

Example embodiments relate to the field of multimedia conferencing systems, for example to communicate with family members who are elderly, disabled, or are not comfortable using such systems and technologies.

### BACKGROUND

Technological progress always leaves some people behind. This is certainly the case in the field of information technology. For example, elderly people may not be able to initiate or control even routine functions of a television or computer. Today's older generations grew up in an analog world which communicated without computers: writing letters, sending telegrams, using rotary dial telephones, listening to radio, and later, watching black and white television programs.

Rapid innovation has left many of the older generation behind, and created a “great divide” between the younger generation who is comfortable with and use the new technologies, and the older generations who aren't familiar or comfortable with the new technologies—or simply cannot use them due to vision or other impairments. On one hand, there are interconnected networks of younger users, while on the other, there still remain large unconnected “islands” of older non-users who are increasingly “out of the loop”.

A difficulty with some computer-based and television-based videoconference systems is that a user receiving a videoconference request is required to enter commands or select functions to accept and control the videoconference connection, and may also be required to control the television as well. This can leave an elderly or technically-challenged user confused and panicked, and may not even be an option for a disabled user.

In another example, some complex videoconference systems require combining and reformatting multiple media sources (including videoconference data and broadcast content) for streaming between end users. However, such systems can be resource intensive, both for the processor and communication bandwidth. Some of such systems may also need to modify the integrity of some original broadcast content in order to adequately provide compressing and combining in real-time over the Internet.

Additional difficulties with existing systems may be appreciated in view of the detailed description of example embodiments below.

### SUMMARY

The invention generally relates to methods and systems for adapting a television for multimedia conferencing.

The system of the invention is designed to close the “great divide” by making multimedia communications technologies available to everyone—especially the elderly, or non-users of any generation who lack technical proficiency or have a disability. By enabling all generations to use the latest technologies to share family experiences, family interconnectedness and inclusiveness is enhanced. This improves the health, well-being and quality of life of both the “sandwich generation” and their elderly parents.

The system enables “virtual visits” among friends and family members—bridging across multiple generations and physical distance—to improve the health, well-being and quality of life of elderly, technically-challenged and/or disabled users. The system is especially designed to meet the needs of the “sandwich generation”—adults with both children and elderly parents to care for—and to help overcome hurdles faced by the elderly and users with disabilities.

The system uniquely provides completely “hands-off” accommodation of an elderly, technically-challenged and/or disabled user. Despite any hurdles such users may face, the system enables them to stay well-connected through “virtual visits” with friends and family members. Such “virtual visits” duplicate the rich shared experience of a personal visit, through audio, video and multimedia conferencing, including the synchronized sharing of personal photos, home videos, or other digital media.

The “hands-off” capability is enabled through a simple, intuitive, controller user interface which is installed on a laptop or other computer-based device. This user interface communicates via the Internet with a player, which is installed, and remains thereafter, at the residence of the player user, the person who is elderly, technically-challenged and/or disabled. The controller user interface provides friends and family members with the means to easily initiate, control and synchronize a “virtual visit” with the player user, remotely controlling the operation of the player, the player user's television and other home entertainment devices, without the player user having to take any action whatsoever.

In an aspect of the invention, there is provided a system for adapting a television for multimedia conferencing, the system for communicating with a controller over the Internet, the television having a plurality of audio/video inputs: a) one of which is available for connection to the system, b) the other(s) available for connection to other media source(s) independent of the system, c) each audio/video input associated with a respective audio/video input mode of the television, the system including:
a) a microphone for capturing spoken audio;
b) a camera;
c) a speaker independent from the television for playing spoken audio; and
d) a computer device including:
   i) a processor which controls the operation of the computer device and the microphone, the camera, and the speaker,
   ii) memory accessible by the processor,
   iii) a network interface for communicating with the controller over the Internet,
   iv) a control interface to at least send commands to the television to control the television operating modes,
   v) a media interface for connecting with the available audio/video input of the television, wherein at least video is sent to the television for display and playback;
      the processor being configured to, in response to commands received from a controller over the Internet, support full control of the system and the television without requiring any action or intervention by a local user of the system, to:
a) establish a spoken audio portion of a multimedia conference with the controller, using the speaker and the microphone,
b) use the control interface to control the operating mode of the television to select the audio/video input mode of the television such that, in a multimedia conferencing mode, at least a video portion of the multimedia conference with the controller is displayed and played by the processor via the media interface on the television, while maintaining the spoken audio portion of the multimedia conference using the microphone and speaker regardless of the audio/video input mode of the television, and
c) play media content stored on the memory on the television, synchronized with the simultaneous playing of identical content stored on the controller, by continuously exchanging time and position information, dynamically corrected for latency, jitter or other impairments characteristic of data communication via the Internet, with video and any associated audio displayed and played on the television whenever the audio/video input mode of the television is set to the audio/video input mode associated with the media interface.

In another aspect of the invention, there is provided a method for adapting a television for multimedia conferencing, the method performed by a computer device based on instructions received from a controller over the Internet without requiring any action or intervention by a local user of the computer device, the television having a plurality of audio/video inputs, each audio/video input associated with a respective audio/video input mode of the television, with one of the audio/video inputs available for connection to a media interface of the computer device, wherein other audio/video input(s) of the television are for receiving media source(s) independent from the computer device, the method including:
a) establishing a spoken audio portion of a multimedia conference with the controller through a speaker independent from the television and a microphone;
b) controlling an operating mode of the television using a control interface of the computer device to select the audio/video input mode of the television such that, in a multimedia conferencing mode, at least a video portion of the multimedia conference with the controller is displayed and played from the computer device to the television, and the established spoken audio portion of the multimedia conference is maintained regardless of the controlled audio/video input mode of the television; and
c) playing media content stored on the computer device simultaneously on the television, synchronized with playback of identical content stored on the controller by the continuous exchange of time and position information, dynamically corrected for latency, jitter or other impairments characteristic of data communication via the Internet, with video and any associated audio being displayed on the television.

In yet another aspect of the invention, there is provided a non-transitory computer-readable medium for adapting a television for conferencing, the non-transitory computer-readable medium containing instructions executable by a computer device based on commands received from a controller over the Internet without requiring any action or intervention by a local user of the computer device, the television having a plurality of audio/video inputs, each audio/video input associated with a respective audio/video input mode of the television, with one of the available audio/video inputs available for connecting the computer device to the television, wherein other audio/video input(s) of the television are for receiving media source(s) independent from the computer device, the instructions including:
a) instructions for establishing a spoken audio portion of a multimedia conference with the controller through a speaker independent from the television and a microphone;
b) instructions for controlling the operating mode of the television using a control interface of the computer device to select the audio/video input mode of the television such that, in a multimedia conferencing mode, at least a video portion of the multimedia conference with the controller is played and displayed on the television, and the established spoken audio portion of the multimedia conference is maintained regardless of the audio/video input mode of the television; and
c) instructions for playing media content stored on the computer device on the television, simultaneously with playback of identical content stored on the controller, in a fully synchronized manner, with video and any associated audio being displayed on the television.

Other advantages, features and characteristics of the invention will become evident upon review of the following description, with reference to the Figures.

### BRIEF DESCRIPTION OF THE DRAWINGS

Embodiments will now be described, by way of example only, with reference to the attached Figures, wherein:

FIG. 1 illustrates a diagrammatic view of a multimedia conferencing system in accordance with an example embodiment of the invention, including a player and a controller for communication over the Internet;

FIG. 2 illustrates a detailed block diagram of the multimedia conferencing system shown in FIG. 1;

FIG. 3 illustrates a detailed diagrammatic view of setup for the player of the multimedia conferencing system shown in FIG. 1;

FIG. 4A shows an example user interface screen displayed on the controller of the multimedia conferencing system shown in FIG. 1, for operation and control of the player by a controller user over the Internet, illustrating a start mode and related functions;

FIG. 4B shows another example user interface screen displayed on the controller, illustrating a visit mode and related functions;

FIG. 4C shows another example user interface screen displayed on the controller, illustrating a show mode and related functions;

FIG. 4D shows another example user interface screen displayed on the controller, illustrating a control mode and related functions;

FIG. 4E shows another example user interface screen displayed on the controller, illustrating an expanded control mode and related functions for remotely controlling an example home entertainment device;

FIG. 4F shows another example user interface screen displayed on the controller, illustrating a finish function and related commands;

FIG. 5 illustrates, in flow diagram form, an example method for configuring a television for multimedia conferencing, in accordance with another example embodiment of the invention;

FIG. 6 illustrates, in flow diagram form, an example method for controlling a media component over a network; and

FIG. 7 illustrates, in flow diagram form, an example method for controlling a media component over a network.

Like reference numerals may be used throughout the Figures to denote similar elements and features.

### DETAILED DESCRIPTION OF EXAMPLE EMBODIMENTS

Example embodiments generally relate to methods and systems for adapting a television for multimedia conferencing.

The following definitions are intended to be illustrative of the example embodiments, and not intended to be limiting.

Reference to controller includes a computer device, such as a desktop computer, laptop, smartphone, tablet computer, or netbook, having enabled software applications for use by a friend or family member. The controller can be mobile, accessibly anywhere with a suitable Internet connection. The controller serves the needs of the friend or family member who wishes to perform a two-way “virtual visit” with an elderly, technically-challenged or disabled user.

Reference to player includes a computer device, such as a desktop computer, laptop, or netbook, connected to the user's existing TV/HDTV, having enabled software applications for controlling the TV and other media devices. The player serves the needs of the elderly, technically-challenged and/or disabled user. The player is operated remotely by the controller via an Internet connection. The player for example is typically maintained in a fixed residential environment. The player may also be identified as a media computer. The player (or media computer) may be connected to a media component, such as the user's TV/HDTV or other audio or video output device.

Reference to player user refers to a user of the player. The player user typically merely views what is displayed on the television and participates in videoconferences or audio conferences.

Reference to controller user refers to a user of the controller. The controller user is typically a more capable user than the player user. Using the simple, intuitive controller user interface, the controller user can simultaneously control and synchronize the operations of both the controller and the player over the Internet.

Reference to television refers to a Standard Definition (SD) television, a High Definition (HD) television, or a display monitor with or without an integrated television tuner and/or integrated speakers.

Reference to media interface refers to the media connections from the player and media players to a television, which can include High Definition Multimedia Interface (HDMI), DVI, VGA, composite, component, coaxial cable, or any other type of industry connection.

Reference to control interface refers to the control connections or signaling from the player to the television and other media devices, such as Consumer Electronics Control (CEC), RS-232, Universal Serial Bus (USB), Bluetooth®, infrared (IR), etc. The control interface is used to send commands to and, depending on the type of interface supported, optionally receive status information from the media devices.

Reference to audio/video (“A/V”) input refers to the A/V input port of a television, which can include High Definition Multimedia Interface (HDMI), DVI, VGA, composite, component, coaxial cable, or any other type of industry connection. Similarly, reference to audio/video (“A/V”) output refers to the A/V output port of the player, which is connected to an available A/V input port of a television.

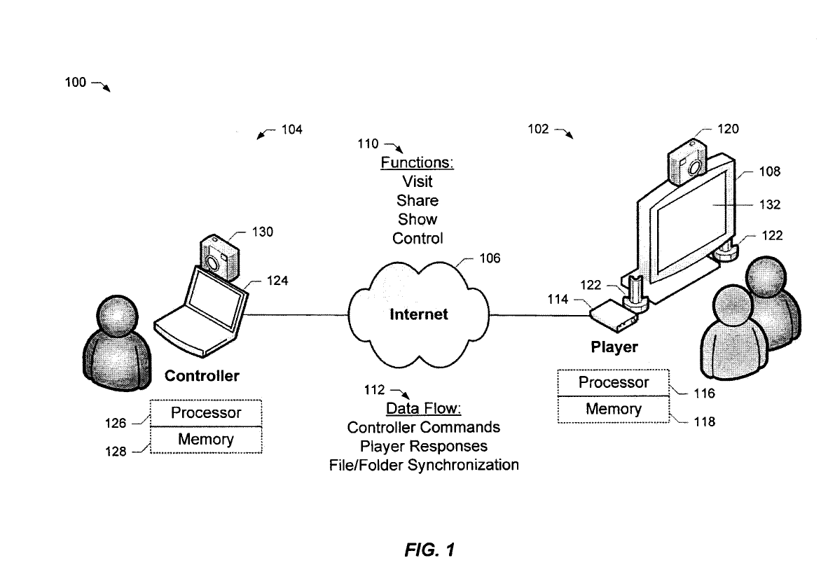

Reference is first made to FIG. 1 which illustrates a multimedia conferencing system 100 in accordance with an example embodiment of the invention. To provide “hands-off” accommodation of an elderly, technically-challenged and/or disabled user, the system 100 includes a player system 102 and a controller system 104 each configured for communication over the Internet 106, each controlled at the controller system 104 by a controller user using a simple, intuitive user interface. Such a user interface that is associated with the controller may be identified as the controller user interface. The player system 102 is installed at the residence of the player user, using some of their user-provided or existing devices, including at least a television 108. The television 108 is adapted for multimedia conferencing using the player system 102. In particular, the player system 102 provides multimedia conferencing and other media services onto the television 108 in response to commands and instructions from the controller system 104. The controller system 104 is controllable by a controller user, such as a family member. A viewer of the television 108, such as an elderly person, does not need to worry about controlling the various functions of the television 108 or the player system 102.

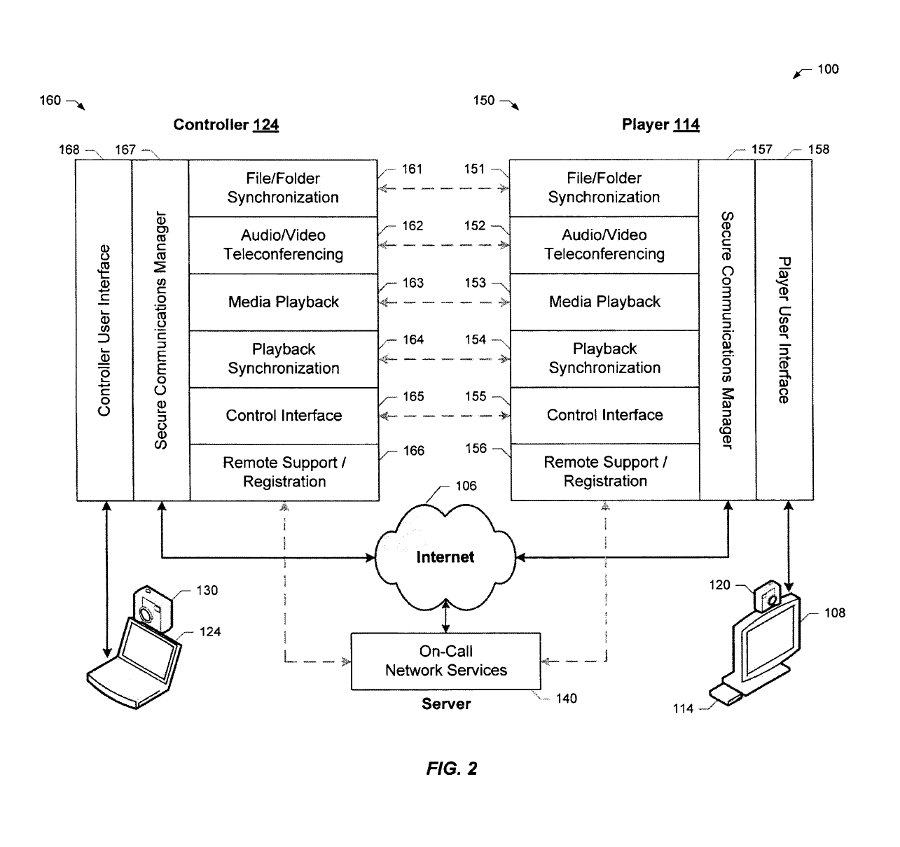

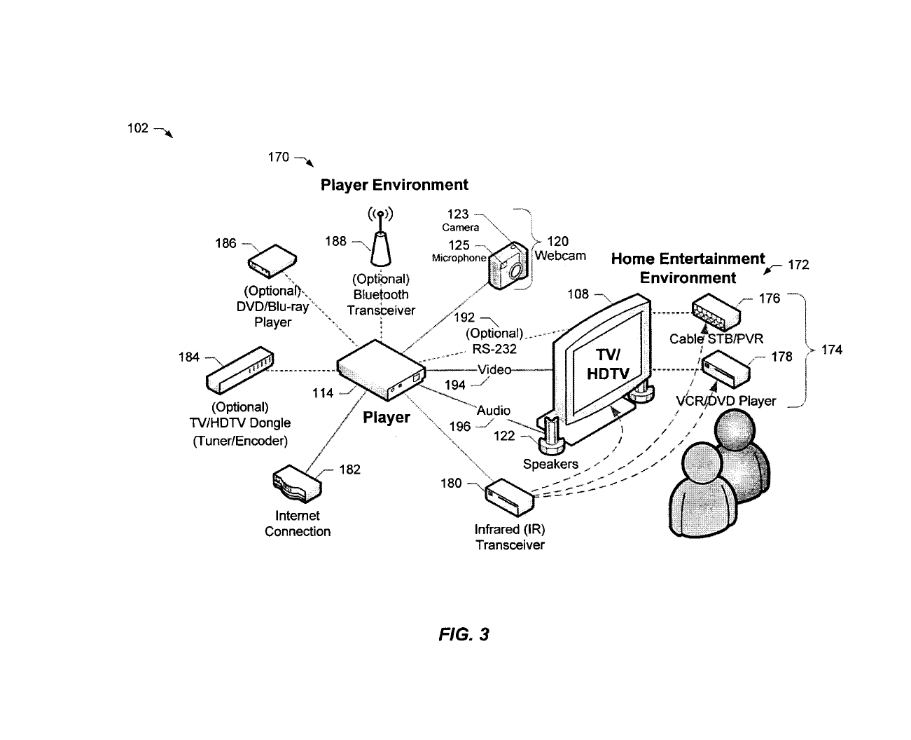

The player system 102, which is installed at the player user's residence, includes a player 114 comprising a processor 116 and memory 118. The player system 102 also includes a webcam 120, and a speaker 122 independent of the television 108 (i.e., the speaker 122 is independently controllable by the player 114 and does not receive audio signals from the television 108). Additional elements and details of the player system 102 are illustrated in FIGS. 2 and 3, described in greater detail herein below. As illustrated in FIG. 3, the webcam 120 typically includes a camera 123 and a microphone 125. Each of the webcam 120, speaker 122, and television 108 may be identified as a media component.

Still referring to FIG. 1, the controller system 104, accessible anywhere having a connection to the Internet 106, includes a computer 124, referred to hereinafter as a controller 124, and comprises a processor 126 and memory 128. The controller system 104 also includes a webcam 130 and speakers (not shown). The webcam 130 typically includes a camera and a microphone. The controller system 104 serves the needs of the friend or family member who wishes to “virtually visit” with an elderly, technically-challenged and/or disabled player user at their residence. Using a simple, intuitive user interface on the controller 124, the friend or family member can simultaneously control and synchronize the operations of both the controller 124 and the player 114 via the Internet 106.

Still referring to FIG. 1, the television 108 includes a display screen 132 used for video output, and built-in or co-located speakers (not shown) for audio output. As is typical, the television 108 has a number of built-in audio/video (A/V) inputs, wherein each A/V input is associated with a respective A/V input mode of the television 108. The television 108 is designed to switch between A/V input modes, as is conventionally performed by using a conventional remote control handset that sends infrared commands to the television 108 to select a desired A/V input mode, etc.

As shown in FIG. 1, example functions 110 or applications implemented by the system 100 include visit, share, show, and control. As shown in FIG. 1, example data flows 112 over the Internet 106 implemented by the system 100 includes controller commands, player responses, and file/folder synchronization.

Briefly, the visit functionality provides multimedia conferencing with high-quality audio-only and combined audio/video modes to enhance warmth, presence, engagement, and context, thereby enabling a true “virtual visit” and proving the adage, “seeing is believing”. This capability promotes rich verbal and visual communications among friends and family members—without long-distance charges.

The share functionality provides easy and secure sharing of media files, such as photos, video and audio files, without requiring any knowledge of file transfer or security/encryption tools for both the controller user of the controller 124 and the player user of the player 114. Each memory 118, 128 can include non-volatile memory and/or persistent memory, wherein each persistent memory can include at least a media storage for storage of media and other files. By simply dropping the desired files into a share folder on the media storage part of memory 128 of the controller 124, the files in the share folder are automatically and securely mirrored with identical copies that are placed in a share folder in the media storage part of memory 118 of the player 114.

The show functionality provides synchronized viewing of media content stored as media files in each media storage part of memory 118, 128—just as if all participants were in the same room. For example, users can show, narrate and discuss family photos—whether historical family albums, or recent photos of family events; such media files can be shown as a “slide show”—a series of images displayed on the television 108. Identical media files are stored in the share folder of each respective media storage part of memory 118, 128 and the display of such images are synchronized on the player 114 and controller 124 so the player user and the controller user are viewing the same image at the same time. Other examples of media content that can be viewed in this way include home videos, movies and audio recordings.

The control functionality allows remotely controlling of the player 114 as well as devices in the home entertainment environment, such as the television 108, DVD player, cable set-top box (STB) and personal video recorder (PVR) (not shown here).

Reference is now made to FIG. 2, which shows the multimedia conferencing system 100 in greater detail. As shown in FIG. 2, a centralized vendor-operated server 140 communicates with the controller 124 and the player 114 over the Internet 106. The server 140 is used to facilitate registration, tracking and billing, provide software applications and updates on a scheduled basis or on demand, and other services.

Referring to the player 114, under instructions from various software applications resident on the player 114, the processor 116 is configured to implement various functional components or modules 150, some of which are represented in FIG. 2, for interacting with related subsystems, the controller 124, and the television 108. In an example embodiment, the software resident on the player 114 includes applications for implementing file/folder synchronization 151, audio/video teleconferencing 152, media playback 153, playback synchronization 154, control interface 155, remote support/registration 156, secure communications manager 157, and player user interface 158. In some embodiments, some or part of the functionality of the functional modules 150 can be implemented through firmware or hardware components instead of, or in combination with, computer software instructions executed by the processor 116 (or other processors).

Similarly, the controller 124 is configured to implement various functional components or modules 160, including file/folder synchronization 161, audio/video teleconferencing 162, media playback 163, playback synchronization 164, control interface 165, remote support/registration 166, secure communications manager 167, and controller user interface 168. The modules 160 can be resident on the controller 124, or in some example embodiments at least some modules 160 or user applications can be accessed in real-time, for example through the server 140 acting as a web server or an application server. For example, the controller 124 may be configured to login or access the server 140 in order to start any sessions or conferences with the player 114. In example embodiments, initial setup of the sessions or conferences is facilitated through the server 140, while the actual content of the sessions or conferences may be communicated peer-to-peer. Another example is to setup the sessions or conferences completely peer-to-peer. Still another example is to use third-party servers for initial setup and monitoring (e.g., using Skype™, as would be understood in the art).

The controller user interface module 168 manages the user interface on the controller 124, including user interactions via, for example, mouse, keyboard, webcam 130, speaker(s), and microphone.

The player user interface module 158 manages the user interface of the player 114, including user interactions via, for example, speakers 122, display 132, and webcam 120. The speakers 122 are provided audio signals through a suitable audio interface 196 (FIG. 3) of the player 114 and may also amplify the signals to the desired playback volume level, as would be understood in the art. It is noted that the player user interface 158 is typically configured to not accept local commands from the player user.

The secure communications manager 157, 167 manages communications via the Internet 106, between each paired modules 150, 160, and between each of the paired modules 150, 160 and on-call network services of the server 140. All such communications over the Internet 106 are secured by public key authentication and encryption, to protect the privacy of personal information, such as digital photos and other media files.

The file/folder synchronization module 151, 161 synchronizes media files in the shared folder in the media storage 118 on the player 114, and the shared folder on in the media storage 128 on the controller 124.

The audio/video teleconferencing module 152, 162 manages the various real-time audio and video portions of a multimedia conference. Using the respective webcams 120, 130 and including associated microphones, the module captures and encodes audio from the microphones as well as video from the webcams, and sends it to the other of the player 114 and controller 124. The module 152, 162 also decodes the audio from the microphones and video from the webcams that it receives, and on the player 114, plays that audio using the speakers 122 and displays that video using the display 132 of the television 108, and on the controller 124, plays that audio and displays that video using its associated speakers and display. The module 152, 162 can also combine video from a local webcam with the decoded video from the remote webcam for display as a “picture-in-picture”.

The media playback module 153, 163 manages the playback of media files (for example, playing a slideshow of digital photos), from local files that are mirrored in the share folder of both the player 114 and controller 124 by using the file/folder synchronization module 151, 161, described above.

The playback synchronization module 154, 164 continuously exchanges time and position information with each other, and dynamically corrects for latency, jitter and other impairments of the Internet 106, while media playback is underway, to synchronize media playback on each of the controller 124 and the player 114 with one another.

The control interface module 155, 165 supports a set of control commands for each supported function, which are exchanged and acknowledged between the controller 124 and the player 114 via the Internet 106.

The remote support/registration module 156, 166 interacts with the on-call network services server 140 to provide registration, software update and configuration services, as well as enabling remote on-call system and user support capabilities, including remote support and trouble-shooting, mediation, and full turnkey operation, monitoring and support.

Reference is now made to FIG. 3, which illustrates a typical setup of the player system 102 in a residence of the player user, which includes a player environment 170 and a home entertainment environment 172, as shown. The home entertainment environment 172 typically includes existing user-provided devices to which the player 114 can be adapted to operate with. As shown, the television 108 is connected to media players 174 such as a cable set top box (STB)/personal video recorder (PVR) 176 and a video cassette recorder (VCR)/Digital Video Disc (DVD) player 178. Each media player 174 provides a media source to the television 108 independent from the player 114 of the invention. That is, these media players 174 do not go through the player 114 to process or relay the media source to the television 108 (or over the Internet 106). The player 114 can control the television 108 and the media players 174 using a control interface, illustrated as an infrared transceiver 180. The infrared commands to control the television 108 and the media players 174 can be programmed into the player 114 from known manufacturer libraries, as is known in the art. As additional options, an RS-232 connection 192 and/or HDMI-CEC signaling (not shown) on the video connection 194, or other signaling technologies or protocols may be used by the player 114 to control televisions 108 having such control capabilities.

The player 114 can provide media to the television 108 using a suitable media interface, illustrated as at least video 194.

The player 114 includes a network interface such as Ethernet or Wi-Fi®, to communicate through an Internet connection 182, preferably a high speed connection. The player environment 170 includes optional accessories such as a TV/HDTV dongle 184 and a DVD/Blu-ray™ player 186, connected to the player 114 through a universal serial bus (USB) or similar interface which integrates both media transfer and control functions. The TV/HDTV dongle 184 is a device which captures television programming either with an over-the-air (OTA) antenna, or by coaxial cable or audio/video connections to a cable/satellite set top box (STB) or personal video recorder (PVR). Such a device can be used to embed PVR capabilities in the player 114, and also allow media players to be operated, configured and programmed remotely by the controller 124, if such features are desired. The DVD/Blu-ray™ player 186 can be used for allow DVD and Blu-ray™ discs to be played directly by the player 114, and for the bulk transfer of digital media files to the media storage 118 of the player 114.

An optional Bluetooth® transceiver 188 can be used to wirelessly link the player 114 to optional Bluetooth® accessories, including stereo earphones for personal listening, and a headset earphone/microphone for conferencing.

Referring again to FIG. 1, the player 114 is configured to merely display an output-only graphical user interface onto the display 132. For example, as a default or in normal use, the interface is not controllable by the player user, nor are there any available user selectable commands or options displayed on the display 132. The player 114 is ultimately controllable by the controller 124, operated by the controller user.

Referring again to FIG. 3, the player 114 has a media interface through an audio/video output port for transmitting audio and video to an A/V input of the television 108, thereby permitting video from the webcams 120, 130 to be displayed on the television 108, and permitting audio and video from media files to be displayed and played on the television 108.

Referring still to FIG. 3, when the spoken audio portion of a multimedia conference (“intercom”) is active, the player 114 is configured to play the spoken audio received from the microphone of the controller 124, through the independent speaker 122, and send spoken audio from the microphone 125 to the controller 124. The player 114 is configured to control the television 108 through the control interface (e.g., infrared transceiver 180 or RS-232 connection 192), to select the desired A/V input mode of the television 108. However, the spoken audio of a multimedia conference is maintained regardless of the A/V input mode of the television 108, for example when the A/V input mode is changed away from the A/V output of the player 114, and hence any active multimedia conference. In other television videoconference systems, both the audio and video portions would typically be lost if the A/V input mode is intentionally or accidentally changed away from the videoconference, which could cause user confusion and even panic when an videoconference session may appear to have been lost or disconnected.

For example, one of the other A/V inputs of the television 108 may receive other media content (audio and video) from one of the media players 174, such as broadcast television content. The player 114 is configured to control the television 108 to switch from the A/V input mode which displays the multimedia conference, to the mode which displays such other media content (or vice-versa). Again, note that the other media content does not stream through the player 114 in such embodiments.

The capability of the player 114 to maintain the spoken audio portion of a multimedia conference regardless of the A/V input mode of the television 108, together with the capability of the player 114 to control the television 108 and the media players 174, enables the player user to make verbal requests of the controller user via the spoken audio portion of the multimedia conference, to control the television 108 or a media player 174. For example, the player user may verbally request the controller user to change the channel, change the volume, turn power on/off, change the A/V input mode, etc. The controller user, in response, can use the user interface of the controller 124 to cause the player 114 to perform the requested function. Note that this aspect of the system does not require any voice-recognition software or the like, as such verbal requests are merely part of the verbal conversation or virtual visit over the audio conference.

In another example embodiment, some televisions 108 have native functions which can display at least two A/V input modes at the same time. Such native functions include a picture-in-picture mode (PIP) or a split-screen mode. In the picture-in-picture mode, typically one A/V input is displayed in the main screen while another A/V input is displayed in a smaller screen in one corner of the television 108. In the present invention, the audio portion of a multimedia conference is maintained regardless of the dual-display mode of the television 108.

A similar functionality exists for the split-screen mode native to some televisions 108, wherein one half of the screen displays one A/V input (e.g. the multimedia conference) and the other half the screen displays a second A/V input (e.g., media content from a media player). Yet some further televisions can display more than two A/V inputs on the screen at a time.

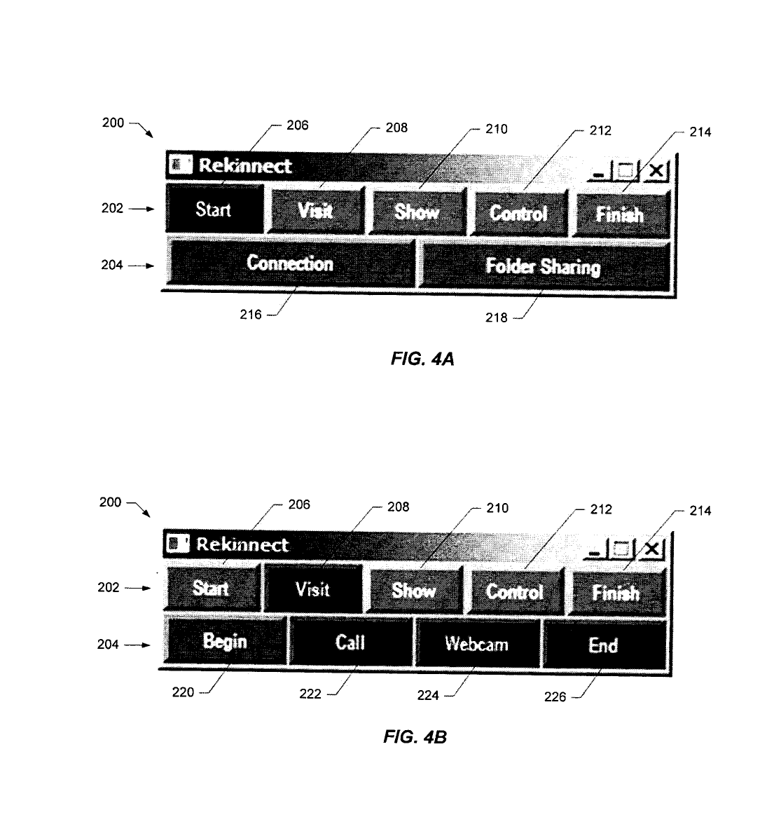

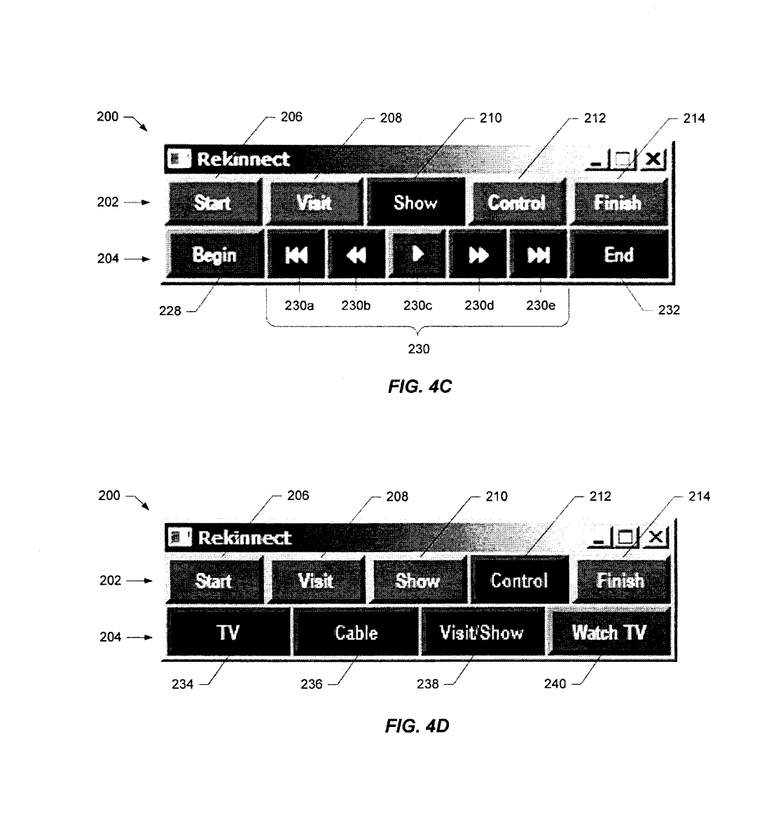

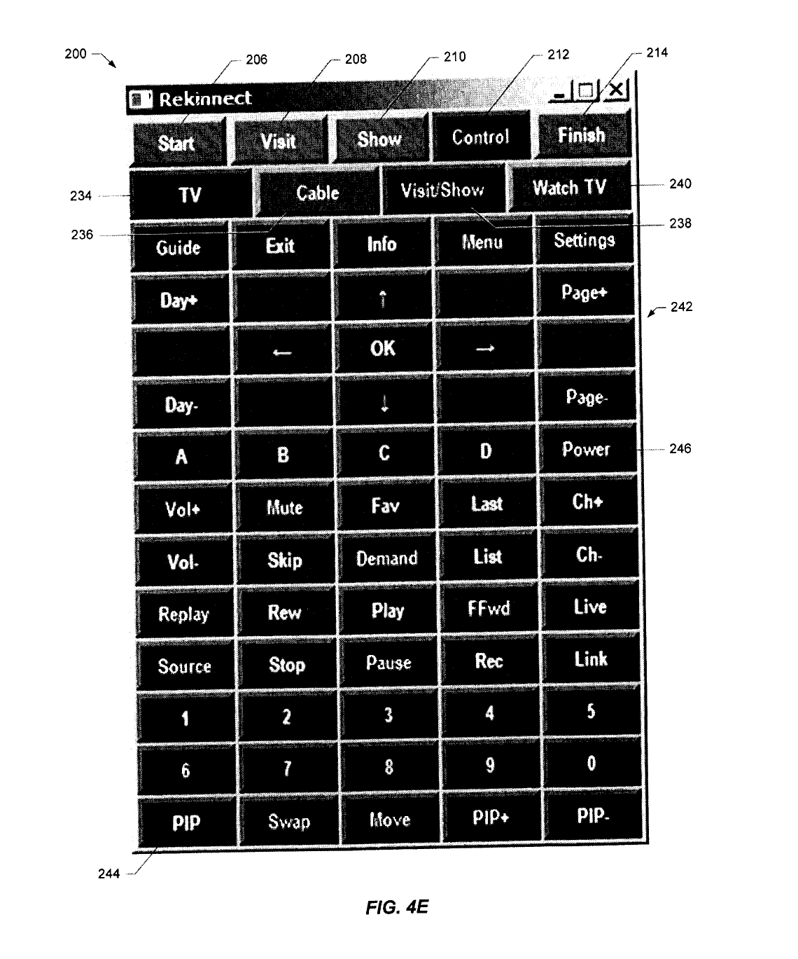

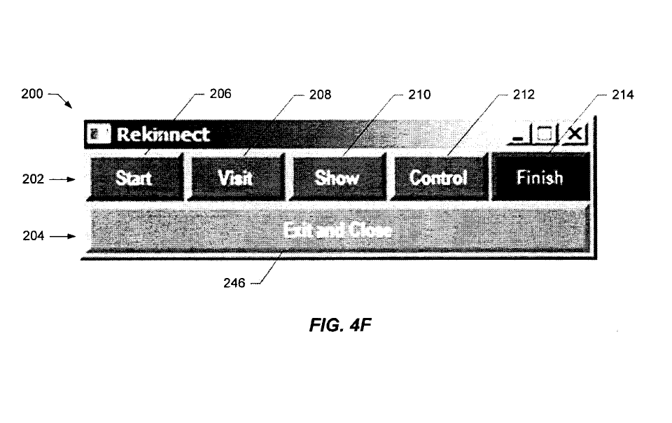

As the player 114 is ultimately controlled by the controller user, by interacting with the graphical user interface (GUI) of the controller 124, example modes of operation of the invention are therefore best illustrated with reference to the example graphical user interface screen (GUI) 200 of the controller 124, as illustrated in FIGS. 4A to 4F. The GUI 200 provides a simple, intuitive interface for the controller user to control the player 114.

Referring now to FIG. 4A, the GUI 200 of the controller 124 can be described as having a row of user-selectable mode buttons 202 and a row of function buttons 204. Each button can be selected by the user, by first moving the cursor on the display screen of the controller 124 to the desired button (e.g., by using a pointing device or mechanism, such as a mouse, touchpad, trackball or similar device), and by then selecting the desired button (e.g., by “clicking” a mouse button or by touching the desired button displayed on a touchscreen). The particular set of function buttons 204 that are displayed according to the particular mode selected via the mode buttons 202. As shown in FIG. 4A, the mode buttons 202 are Start 206, Visit 208, Show 210, Control 212 and Finish 214.

In some examples, the buttons 202, 204 change color in response to the present context to provide feedback to the user of the controller 124. The mode buttons 202 can change color as follows: light grey indicates that the mode is not selected; dark grey indicates that the mode is selected, and the function buttons relate to the selected mode. Only one mode button may be selected at any time.

The function buttons 204 can change color as follows: dark grey indicates that the function is not currently active; amber indicates that the controller 124 and player 114 are attempting to perform the function; green indicates that the controller 124 and player 114 have successfully performed the function, and/or the function is currently active; red indicates that the controller 124 and/or player 114 have failed to successfully perform the function.

Referring still to FIG. 4A, upon selection of the Start mode button 206 (or any start-up of the program), in response the function buttons 202 displayed are Connection 216 and Folder Sharing 218. Selection of Connection 216 establishes, if the button 216 not currently active, a communications path between the controller 124 and the player 114 via the Internet 106, and ensures that the controller 124 and player 114 are ready to communicate with one another. A Secure shell (SSH) client is launched to establish an encrypted path from the controller 124 (the SSH client) to the player 114 (the SSH server) using public key authentication, followed by an exchange of event messages (“handshake”) to confirm that the controller 124 and the player 114 are connected and ready. If the button 216 is active, selection of Connection 216 terminates the communications path. The SSH client is terminated, removing the encrypted path from the controller 124 to the player 114.

Selection of Folder Sharing 219, if the button 219 is not currently active, synchronizes the contents of the controller's 124 shared folder (e.g., digital photos to be shown as a “slide show”) with the contents of the player's 114 shared folder, so the player 114 has an exact copy of the contents of the controller's 124 folder. The directories and files are synchronized using SSH encryption for security and delta encoding to identify and transfer only those files that have changed. If the Folder Sharing button 219 is currently active, selecting the button 219 resynchronizes the folders.

Referring now to FIG. 4B, upon selection of the Visit mode button 208, in response the function buttons 202 displayed are Begin 220, Call 222, Webcam 224, and End 226. Upon selection of Begin 220, if a “virtual visit” is not currently active, the capability to conduct a “virtual visit” or multimedia conference is established at both the controller 124 and the player 114. The Visit application is started on both the controller 124 and the player 114, and the application programming interface (API) is attached to control the functionality of the controller 124 and the player 114. If a “virtual visit” or multimedia conference is currently active, upon selection of Begin 220, the capability to conduct a “virtual visit” or multimedia conference is terminated.

Upon selection of Call 222, the spoken audio portion of a multimedia conference (“intercom”) is initiated between the controller 124 and the player 114. The player 114 is configured to automatically answer. When communications are successfully established, a tone is first sounded on the speaker 122 of player 114, to announce the beginning of the call, and the controller user and the player user can then converse in real time with one another, with the spoken audio played on speaker 122 irrespective of the A/V input mode of the television 108.

Before selecting Webcam 224, in order to respect the privacy of the player user, and to avoid interrupting any TV program being viewed by the player user, the controller user can first use the spoken audio “intercom” initiated by Call 222, to ask the player user whether it would be convenient to add video to the multimedia conference. If the user agrees, the controller user can then use Webcam 224 to turn the video of both the player 114 and the controller 124 on or off simultaneously. If the A/V input mode of the television 108 has not already been set to the A/V output of the player 114, it can automatically be set accordingly at this point, via the control interface.

Upon selection of End 226, the multimedia conference (including webcam video, if the webcam is on) is terminated. Then, the “virtual visit” application is terminated on both the controller 124 and the player 114.

Referring now to FIG. 4C, upon selection of the Show mode button 210, in response the function buttons 202 displayed are Begin 228, media navigation buttons 230, and End 232. The Show mode is used to establish and control the playing of media that is stored in the shared folder, as part of a multimedia conference, or “virtual visit,” then in progress. For example, if photos have been stored in the shared folder, they will be displayed as a “slide show”, which provides synchronized photo sharing between the controller 124 and the player 114, accompanied simultaneously by narration and discussion using the audio communications capabilities of Visit, which is maintained throughout the slide show.

Upon selection of Begin 228, the Show application (media playback module 153, 163) is initiated, and playing of media that is stored in the shared folder begins. For example, if photos are stored in the shared folder, a synchronized full-screen “slide show” begins with the first photo in the shared folder of both the player 114 and controller 124, with the same photo displayed simultaneously on the controller 124 and the player 114. If the A/V input mode of the television 108 has not already been set to the A/V output of the player 114, it can be done automatically at this point.

The navigation buttons 230 are used to move among individual media files stored in the shared folder and control playback. They comprise first button 230a, previous button 230b, play button 230c, next button 230d, and last button 230e. Selection of the first button 230a selects and plays the first media file in the shared folder, or may skip to the first part of the media file currently being played, if media playback is already underway. For example, if photos are stored in the shared folder, this controls the Show application (media playback module 153, 163) to display the first photo in the shared folder.

Selection of the previous button 230b selects and plays the previous media file in the shared folder, or skips to a previous part of the media file currently being played, if media playback is already underway. For example, if photos are stored in the shared folder, this controls the Show application (media playback module 153, 163) to display the previous photo in the shared folder.

Selection of the play button 230c toggles between playing the media (turns Green), or pausing the media playback (turns Dark Grey). For example, if photos are stored in the shared folder, when the play button 230c is toggled on, a “slideshow” begins to cycle sequentially through the photos stored in the shared folder, displaying each photo for some configurable time (by default, eight seconds), before triggering the next function (of the next button 230d) to select and play the next photo in the shared folder. In this example, when the play button 230c is toggled off, the next function (of the next button 230d) is no longer triggered automatically, and the current photo remains displayed until another function is initiated.

Selection of the next button 230d selects and plays the next media file in the shared folder, or skips to the next part of the media file currently being played, if media playback is already underway. For example, if photos are stored in the shared folder, this controls the Show application (media playback module 153, 163) to display the next photo in the shared folder.

Selection of the last button 230e selects and plays the last media file in the shared folder, or skips to the last part of the media file being played, if media playback is already underway. For example, if photos are stored in the shared folder, this controls the Show application (media playback module 153, 163) to display the last photo in the shared folder.

Upon selection of End 232, the playing of media that is stored in the shared folder ends, and the controller 124 and the player 114 terminate the Show application (media playback module 153, 163). For example, if photos are stored in the shared folder, the synchronized “slideshow” will no longer be displayed by the player 114 and controller 124.

Referring now to FIG. 40, upon selection of the Control mode button 212, in response the function buttons 202 displayed are TV 234, Cable 236, Visit/Show 238, and Watch TV 240. The Control mode is used to control the audio and video communications setup of devices in the home entertainment environment 172 (FIG. 3). Such devices can be controlled using the control interface such as infrared (IR) or RS-232, issuing commands specific to the particular device type, manufacturer, and model. In the example illustrated in FIG. 3, such devices include a television 108 and a Cable set-top box (STB) 176. The player 114 normally performs appropriate control functions automatically, when a particular Visit, Show or Finish function is selected.

Control mode is intended to be used by the controller user to remotely operate the home entertainment equipment or, on an exception basis, as a “toolkit” to control devices to assist the player user in dealing with inadvertent situations or difficulties. For example, as part of a normal “virtual visit”, if the player user needed assistance in finding a particular program to watch, the controller user could use the Cable function 236 to assist the player user in searching the program guide and selecting the desired program. The user interface for this example, from the controller user's perspective, is illustrated in the remote control buttons 242 for the Cable STB 176 shown in FIG. 4E.

As an example of assisting the player user in dealing with an inadvertent situation, if the Cable STB had inadvertently been turned off, and the player user needed assistance to turn it back on, the controller user could use the Cable function 236 to select the Power button 246 shown in FIG. 4E to toggle the Cable STB power on.

Referring still to FIG. 4D, upon selection of TV 234, the TV remote control GUI (not shown) will be toggled on or off. As a complete set of TV remote control buttons is then available on the GUI, the controller user can control all of the TV functions on behalf of the player user. Examples of such functions include turning the TV on or off, changing the volume, or selecting a desired A/V input. The TV button 234 turns green when the TV remote control buttons are toggled on, and turns dark grey when they are toggled off. As long as the expanded set of TV remote control GUI 242 continues to be displayed, pressing each button causes the matching command to be sent to the television 108 at the player location using the control interface. Depending on the type of IV, such commands may be output through the control interface as infrared (IR) commands through the IR transceiver 180, RS-232 commands through the RS-232 connection 192 (FIG. 3), or as other types of commands, such as CEC. If RS-232, CEC or another type of bidirectional control interface is used to communicate with the television 108, the player 114 can be configured to determine certain states or operating modes of the television 108, such as whether power is on or off (in this case, the Power button on the TV remote control GUI on the controller 124 will turn Green when the television 108 is determined to be on, and turn Dark Grey otherwise). A bidirectional control interface may also allow the current status of other functions such as currently-selected A/V input, channel and volume level to be displayed on the TV remote control GUI on the controller 124.

Upon selection of Cable 236, the Cable set-top box (STB) remote control GUI 242 shown in FIG. 4E will be toggled on or off. Referring to FIG. 4E, with this complete set of STB remote control buttons, the controller user can control all STB functions, such as using the Power button 246 to turn the STB power on or off, using the picture-in-picture (PIP) button 244 to activate the PIP feature, or using other buttons to change channels, select a program for the player user to watch or record from the channel guide, or control other functions of the Cable STB 176. The Cable button turns green when the STB remote control GUI 242 is toggled on, and turns dark grey when toggled off. As long as the complete set of STB remote control buttons continues to be displayed in the GUI 242, pressing each button causes the matching command to be sent to the Cable STB 176 at the player location, using the control interface of the player 114.

Referring again to FIG. 4D, upon selection of Visit/Show 238, a control command is sent to the television 108 to switch the A/V input mode to the player 114. The Visit/Show button 238 turns green when the A/V input is set to the player 114, and turns dark grey otherwise. Depending on the type of television 108, a suitable device control command is sent by the player 114 via the control interface to switch the A/V input of the television 108 to the player 114. To accommodate different models of televisions, the player 114 is configured to provide a suitable video signal to the television 108.

Upon selection of Watch TV 240, a control command is sent to the television 108 to switch the A/V input mode to the Cable STB 176 (or other desired source of TV programming). The Watch TV button 240 turns green when the A/V input is set to the Cable STB (or other desired source of TV programming), and turns dark grey otherwise. Depending on the type of television 108, a suitable device control command is sent by the player 114 via the control interface to switch the A/V input of the television 108 to the Cable STB 176 (or other desired source of TV programming).

The player 114 can be configured to switch to any source of TV programming connected to the A/V inputs of the television 108, whether over-the-air, analog cable, digital cable with or without an external STB, or any other source, including coaxial cable (e.g., RF modulated on channel 3 or 4), composite video, component video, DVI and HDMI.

Referring now to FIG. 4F, upon selection of the Finish mode button 214, in response the function button 204 displayed is Exit and Close 246. Finish mode 214 is used by the controller user prior to confirming their wish to exit from any “virtual visit” currently underway, and close all of the applications and windows, including the controller GUI 200. Selection of the Exit and Close button 246 confirms this, and results in several actions being completed in sequence: (1) exit from the “virtual visit”; (2) terminate the visit and show applications on both the player 114 and the controller 124; (3) optionally, initiate the Control 212 function Watch TV 226, to switch the A/V input of the television 108 to the Cable STB 176 (or other desired source of TV programming); (4) terminate communications and the secure shell session between the controller 124 and the player 114; (5) close the controller GUI 200 window and terminate the underlying program on the controller 124.

Referring again to FIG. 2, the functions of the server 140 will now be described in greater detail. The vendor of the server 140 can provide on-call network services and support services as part of recurring monthly subscription fee. These services maintain peace-of-mind to users and an ongoing revenue stream for the vendor operating the server 140.

On-call network services of the server 140 include, for example, modules for Registry, Updater, and Configurator. The Registry uses the unique keys preloaded in each player and controller to enforce licensing of the software, establish connections between the controller and player, and secure the information transferred through an encryption key. The Updater automatically updates the player and controller applications software suite with the latest versions. Using information on the home entertainment environment 172 (as shown in FIG. 3) which has been provided or updated by the controller user, the Configurator automatically configures the player 114 and optionally, the controller 124, to work with the specified models of television 108 and attached media players 174 (as shown in FIG. 3), by accessing a library of corresponding configuration information. The appropriate library of commands and GUI templates can be pushed to the player 114 and optionally, controller 124, from the server 140 during the initial player configuration process or whenever changes are subsequently made to the home entertainment environment 172.

Actual support services performed by the vendor can include:

Player Installation which refers to the vendor providing a qualified installation technician who will perform an on-site installation and setup of the player 114, connect it to an existing high-speed Internet service (DSL, cable or fiber-optic), register, verify remote maintainability, and provide user familiarization.

Controller Installation which refers to the vendor providing a qualified installation technician who will perform an online or on-site installation and setup of the controller 124, register, verify remote maintainability, and provide user familiarization training.

Online Training which refers to a library of self-paced online training courses will provide a multi-purpose training resource for users, as well as for installation technicians and system support personnel.

Remote Support which refers to the remote installation, operation and remote trouble-shooting assistance that will be provided to assist users and installation technicians in installing, operating and maintaining the player 114 and the controller 124.

Mediation which refers to multimedia communications that will be scheduled and set up between users in order to demonstrate a new installation, or as a value-added service to those who are uncomfortable using the controller directly.

Turnkey Solution which refers to the vendor taking care of everything required to provide and support the system on a turnkey basis. This includes sourcing required components (such as HDTV and Internet access), installation and configuration of the controller, player and other components, and day-to-day operation, monitoring and support of the complete solution.

Referring again to FIG. 3, in an example package, the player system 102 may be provided to the consumer in a package or kit of parts, including: the player 114 with external power supply; the webcam 120; the speakers 122, audio cables and external power supply; the infrared transceiver 180; HDMI cable to connect the player 114 to the television 108; and an Ethernet cable to connect the player 114 to the Internet connection 182.

In some example embodiments, at least some components of the player system 102 can be provided in an integrated package. For example, at least the player 114, the speakers 112, and the webcam 120 can have a common housing or packaging, such that positioning of the housing on the television 108, and then connecting the player system 102 to an available A/V input on the television 108, to the Internet connection 182 and to power may be the only assembly required to start operation of the player system 102.

Other optional accessories, available separately, can include: the RS-232 adapter 192 with a suitable RS-232 cable; TV/HDTV dongle 184; DVD/Blu-ray™ player 186; and Bluetooth® transceiver 188.

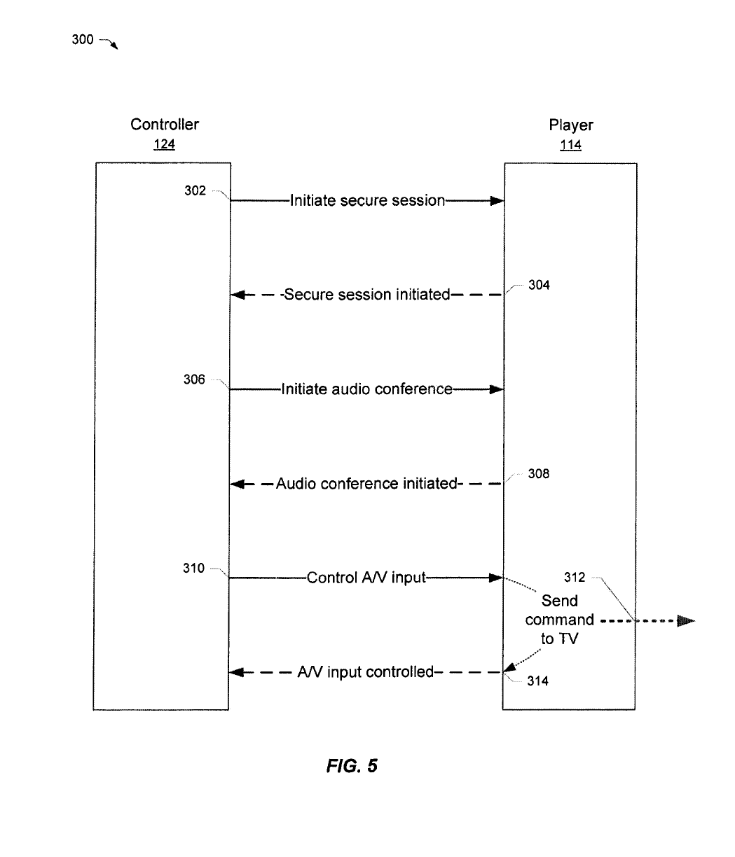

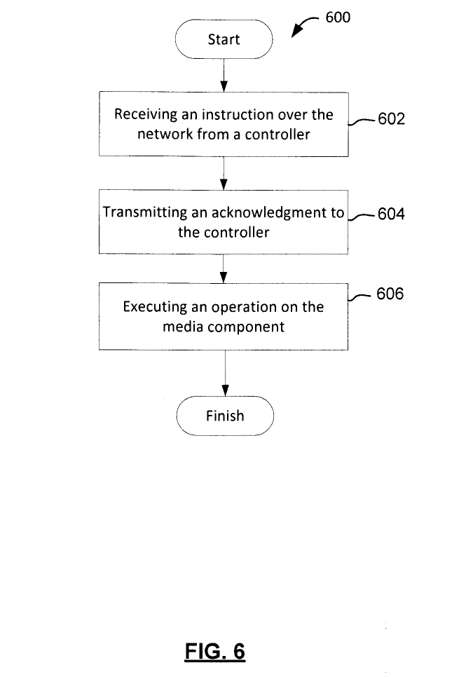

Reference is now made to FIG. 5, which illustrates an example method 300 for configuring the television 108 for multimedia conferencing, including a “virtual visit”, in accordance with another example embodiment of the invention. One A/V input of the television 108 is for receiving a media source independent from the player 114, such as from a television broadcast or from a media player 174. A second A/V input of the television 108 is for receiving video and associated audio from the player 114 for a “virtual visit”, including multimedia conferencing, incorporating a shared media experience such as a slideshow. At event 302, the controller 124 initiates a secure session with the player 114 and requests confirmation from the player 114 that the session has successfully been initiated. For example, the player 114 runs the secure server, and the controller 124 runs the secure client; the controller 124 initiates the secure session, which is then established by the secure client exchanging and verifying keys with the secure server; the controller 124 then requests confirmation that the secure session has been established by sending a message to this effect via the secure session. At event 304, the player 114 responds to this request by sending a confirmation message to the controller 124 via the secure session; this two-way message exchange confirms that the secure session has been successfully initiated. At event 306, the controller 124 initiates the spoken audio portion of a multimedia conference with the player 114; the player automatically answers and sends its confirmation at event 308, and the spoken audio from the controller's 124 microphone is played by the player 114 through the speakers 122. At event 310, the controller 124 instructs the player 114 to change the A/V input of the television 108. For example, it may be desired to switch the television 108 to the A/V input relating to the player 114, permitting the television 108 to display the video and associated audio portion of a multimedia conference, including shared media such as a photos or home video. In another example, the A/V input of the television 108 may be changed to the media source independent from the player 114. The spoken audio portion of any multimedia conference is maintained by the player 114 through the speakers 122, regardless of the A/V input mode of the television 108.

At event 312, the player 114 uses its control interface to set the A/V input mode of the television 108 as instructed by the controller 124. At event 314, the player 114 confirms to the controller 124 that the A/V input mode was set as instructed.

The method 300 may be performed between the controller 124 and the player 114 over the Internet 106, and can be peer-to-peer (as shown). In other example embodiments, at least some steps or events may be facilitated by the server 140 (not shown here), for example events 302 and 304. It would be appreciated that some example embodiments of the product can provide remote control of a virtual visit capability “out of the box”, which requires basic or minimal setup while providing a simple, intuitive user interface for the controller and optionally the player.

It would be appreciated that some example embodiments can provide software management. Unique controller and player keys provide the means to enforce proper licensing of the software, establish connections between the controller and player through the server registry, and securely transfer encrypted information via the Internet.

It would be appreciated that some example embodiments can provide application integration. The system integrates with third-party application software to provide shared functionality synchronized between the controller and player, either using Application Program Interfaces (APis) or alternatively by mimicking user-initiated commands by controlling the application's user interface.

It would be appreciated that some example embodiments can provide device integration. The system is not just a stand-alone solution; it has the capability to integrate and control not only the television but also all other connected components of the home entertainment environment, such as a cable STB, and/or a VCR/DVD player.

It would be appreciated that all player device control information is synchronized with the controller, so that the player and devices in the home entertainment environment can be controlled remotely by the controller.

It would be appreciated that some example embodiments can provide media mirroring. Media mirroring takes place between the controller and the player through the respective mirrored shared folders. As both the controller and the player each have their own identical copy of all media files, playback is of uniformly high quality, and the jitter, drops, pauses and lower fidelity audio/video that are common with streaming solutions is eliminated.

It would be appreciated that some example embodiments can provide playback synchronization. As multiple forms of media files including full motion video and still photos are played on both the controller and the player, playback is synchronized to ensure that both the controller user and the player user are looking at identical images and hearing identical audio at the same time, to maximize the media experience as well as enable natural real-time interaction between the users.

It would be appreciated that some example embodiments can provide privacy/security. By storing media only on the controller and the player, and transferring it securely between the two units using unique keys, all media files identified for sharing are kept private and are not accessible to other Internet users or websites. Personal media files, such as photos of children and grandchildren, are thereby kept away from preying eyes.

It would be appreciated that some example embodiments can be adapted for mobile evolution. A mini-controller can provide a subset of the controller functionality using smart phones and other mobile devices with Internet access.

In accordance with an example embodiment of the invention, there is provided a system for adapting a television for multimedia conferencing, the system for communicating with a controller over the Internet, the television having a plurality of audio/video inputs: a) one of which is available for connection to the system, b) the other(s) available for connection to other media source(s) independent of the system, c) each audio/video input associated with a respective audio/video input mode of the television, the system including:
a) a microphone for capturing spoken audio;
b) a camera;
c) a speaker independent from the television for playing spoken audio; and
d) a computer device including:
   i) a processor which controls the operation of the computer device and the microphone, the camera, and the speaker,
   ii) memory accessible by the processor,
   iii) a network interface for communicating with the controller over the Internet,
   iv) a control interface to at least send commands to the television to control the television operating modes,
   v) a media interface for connecting with the available audio/video input of the television, wherein at least video is sent to the television for display and playback;
      the processor being configured to, in response to commands received from a controller over the Internet, support full control of the system and the television without requiring any action or intervention by a local user of the system, to:
a) establish a spoken audio portion of a multimedia conference with the controller, using the speaker and the microphone,
b) use the control interface to control the operating mode of the television to select the audio/video input mode of the television such that, in a multimedia conferencing mode, at least a video portion of the multimedia conference with the controller is displayed and played by the processor via the media interface on the television, while maintaining the spoken audio portion of the multimedia conference using the microphone and speaker regardless of the audio/video input mode of the television, and
c) play media content stored on the memory on the television, synchronized with the simultaneous playing of identical content stored on the controller, by continuously exchanging time and position information, dynamically corrected for latency, jitter or other impairments characteristic of data communication via the Internet, with video and any associated audio displayed and played on the television whenever the audio/video input mode of the television is set to the audio/video input mode associated with the media interface.

In accordance with another example embodiment of the invention, there is provided a method for adapting a television for multimedia conferencing, the method performed by a computer device based on instructions received from a controller over the Internet without requiring any action or intervention by a local user of the computer device, the television having a plurality of audio/video inputs, each audio/video input associated with a respective audio/video input mode of the television, with one of the audio/video inputs available for connection to a media interface of the computer device, wherein other audio/video input(s) of the television are for receiving media source(s) independent from the computer device, the method including:
a) establishing a spoken audio portion of a multimedia conference with the controller through a speaker independent from the television and a microphone;
b) controlling an operating mode of the television using a control interface of the computer device to select the audio/video input mode of the television such that, in a multimedia conferencing mode, at least a video portion of the multimedia conference with the controller is displayed and played from the computer device to the television, and the established spoken audio portion of the multimedia conference is maintained regardless of the controlled audio/video input mode of the television; and
c) playing media content stored on the computer device simultaneously on the television, synchronized with playback of identical content stored on the controller by the continuous exchange of time and position information, dynamically corrected for latency, jitter or other impairments characteristic of data communication via the Internet, with video and any associated audio being displayed on the television.

In accordance with yet another example embodiment of the invention, there is provided a non-transitory computer-readable medium for adapting a television for conferencing, the non-transitory computer-readable medium containing instructions executable by a computer device based on commands received from a controller over the Internet without requiring any action or intervention by a local user of the computer device, the television having a plurality of audio/video inputs, each audio/video input associated with a respective audio/video input mode of the television, with one of the available audio/video inputs available for connecting the computer device to the television, wherein other audio/video input(s) of the television are for receiving media source(s) independent from the computer device, the instructions including:
a) instructions for establishing a spoken audio portion of a multimedia conference with the controller through a speaker independent from the television and a microphone;
b) instructions for controlling the operating mode of the television using a control interface of the computer device to select the audio/video input mode of the television such that, in a multimedia conferencing mode, at least a video portion of the multimedia conference with the controller is played and displayed on the television, and the established spoken audio portion of the multimedia conference is maintained regardless of the audio/video input mode of the television; and
c) instructions for playing media content stored on the computer device on the television, simultaneously with playback of identical content stored on the controller, in a fully synchronized manner, with video and any associated audio being displayed on the television.

With reference to FIGS. 1 and 2, the player 114 may also be identified as the media computer 114. Similarly, the television 108 may be an example of a media component 108. Other media components 108 can include audio and/or video output devices.

In accordance with one or more embodiments, described is a system for controlling a media component, the system comprising: a controller 124; and, a media computer 114 for communicating with the controller 124 over a network 106, the media computer 114 connected to the media component 108 for executing operations on the media component 108, the media computer 114 comprising a memory 118 with instructions stored thereon and a processor 116 for executing instructions.

In accordance with one or more embodiments, described is a method of controlling a media component 108 over a network 106, the method executed on a processor 116 and comprising: receiving an instruction over the network 106 from a controller 124; in response to receiving the instruction, transmitting an acknowledgment over the network 106 to the controller 124; and executing an operation on the media component 108, the operation being identified in the instruction.

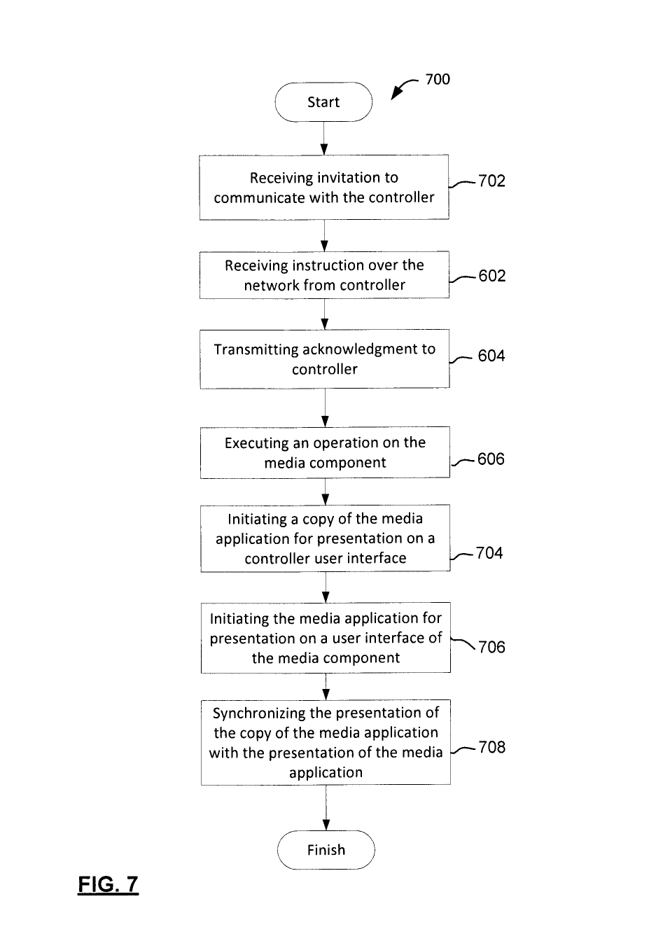

FIG. 6 is a flowchart depicting an exemplary method 600 of controlling a media component 108 over a network 106. In one or more embodiments, the media component 108 comprises one or more of cable box, a PVR, a DVD, an audio speaker, a video output, an audio-video output and a television 108.

The network 106 can be the Internet, for example. By way of further example, the network 106 can be any network that uses the TCP/IP protocol to transmit data.

At 602, an instruction is received over the network 106 from a controller 124. For example, the instruction may be transmitted from a controller to a media computer 114 using TCP/IP. Accordingly, the controller 124 may be located remotely from the media computer 114.

At 604, in response to receiving the instruction, an acknowledgment is transmitted over the network 106 to the controller 124. For example, the media computer 114 or an application or process operating on the media computer 114 may automatically transmit an acknowledgement to the controller 124. Such an automatic transmission may be performed in response to receiving the instructions from the controller 124.

At 606, an operation is executed on the media component 108. The operation can be identified in the instruction. For example, the instruction transmitted by the controller 124 to the media computer 114 may include the identification of an operation. An operation can be to launch an application on the media component 108, to download a file onto the media component 108, to open a file, to exit a file, to change the channel on the television 108, etc. The media computer 114 may receive the instruction and determine, from the instruction, the type or identity of the operation. The media computer 114, which is coupled to the media component 108, may then execute the operation on the media component 108.

In one or more embodiment, the media computer 114 can be a desktop computer, a laptop computer, a tablet, a handheld computer, a portable computer or any other computer that has a processor 116 and that is associated with a memory 118, for example.

In one or more embodiments, the operation may be executed using one or more of an infrared transceiver that is optically coupled to the media component 108 being controlled, an RS232 serial interface that is electrically connected to the media component 108 being controlled, and an Ethernet interface that is electrically connected to the media component 108 being controlled.

In one or more embodiments, the acknowledgement transmitted to the controller 124 is a confirmation that the instruction was received or a verification that operation was executed, or both. For example, the acknowledgment may not be transmitted to the controller 124 until after the operation is executed by the media computer 114 on the media component 108.

FIG. 7 is a flow-chart illustrating another exemplary method 600 of controlling a media component 108 over a network 106.

Optionally, at 702, before receiving the instruction (at 602), an invitation to communicate with the controller 124 is received. In one or more embodiments, the invitation comprises an invitation transmitted over Voice-over-Internet-Protocol (VoIP) to communicate with the controller 124 using VoIP. In such embodiments, the invitation may consist of the receipt of an incoming call or call initiation.

In a further, example, the invitation may consist of a handshake between the controller 124 and media computer 114. Further, the invitation may consist of a call initiation, a call receipt and a call acceptance. In one or more embodiments, the operation of the media component 108 is interrupted for the duration of the incoming invitation. The interruption may consist of a pausing or temporarily ceasing of the operation of the media component 108. For example, the operation of the media component may be the presentation or display of video or the presentation or output of audio or other media content and the interruption may result in the media component 108 pausing the presentation or output of the media content.

In one or more embodiments, the media component 108 is an audio speaker. In such embodiments, in response to the interruption the media computer 114 may automatically lower the volume of the audio emitted from the media component 108 (or audio speaker) for the duration of the interruption. If the interruption results in an established communication channel (e.g. if the incoming call is accepted), then the output of the media component 108 may resume to the previous volume levels or, alternatively, the output of the media component 108 may pause for the duration of the communication between the controller 124 and media computer 114.

In one or more embodiments, the instruction comprises an instruction to present a media application and wherein the operation comprises presenting the media application. In such an embodiment, the method 600 may further comprise the following three optional steps.

After the invitation to communication with the controller 124 is received (at 702), the method may progress through steps 602, 604 and 606 as identified in FIG. 6.

At 704 a copy of the media application is initiated for presentation on a controller user interface. The controller user interface is associated with the controller 124. For example, the controller user interface may be a display screen coupled to the controller 124. Alternatively, or additionally, the controller user interface may be an audio interface or an audio-visual interface coupled to the controller 124.

At 706, the media application is initiated for presentation on a user interface of the media component 108. For example, the media component 108 may be a television or computer monitor and the user interface may be the display screen.

At 708, the presentation of the media application on the user interface of the media component 108 is synchronized with the presentation of the copy of the media application on the controller user interface.

In one or more embodiments, the interface of the media component 108 is a video output, audio output or video-audio output, such as a display screen.

In one or more embodiments, disclosed is a system for controlling the media component 108. The system comprises a controller 124 and a media computer 114. The media computer 114 is connected to the media component 108 for executing operations on the media component 108. As described above, the media computer 114 includes a memory 118 with instructions stored thereon and a processor 116 for executing instructions.

The media computer 114 can also include one or more interfaces to the media component 108. The one or more interfaces can include one or more of Consumer Electronics Control (CEC), Universal Serial Bus (USB), RS232. Ethernet, Bluetooth or an infrared emitter.

In one or more embodiments of the system, an infrared transceiver is connected to the media component 108 and in communication with the media computer 114. The infrared transceiver can receive instructions from the media computer 114 and can map the received instructions to an infrared signal, which can then be sent to the media component 108.

In one or more embodiments, the system can include a controller interface, and wherein the controller 124 is configured to synchronize the presentation of a duplicate version of a media application on the controller user interface and the presentation of the media application by the media computer 114 on a user interface of the media component 108.

Further, the controller 124 and media computer 114 can be configured to transmit communications over the network while the media application and duplicate media application are presented in synchronicity. Such communications can comprise video and/or audio communication. For example, such communications can be VoIP.

According to another aspect, described is a computer readable medium comprising processor-executable instructions which, when executed, cause a processor 116 to: receive an instruction over a network 106 from a controller 124; in response to receiving the instruction, transmit an acknowledgment over the network 106 to the controller 124; and execute an operation on a media component 108, the operation being identified in the instruction.

In one or more embodiments of the computer readable medium, the instruction comprises an instruction to present a media application, wherein the operation comprises presenting the media application on a user interface of the media component 108, and wherein the processor 116 is further configured to synchronize the presentation of the media application on the interface of the media component 108 with the presentation of a duplicate of the media application on a controller interface associated with the controller 124.

While some of the present embodiments are described in terms of methods, a person of ordinary skill in the art will understand that present embodiments are also directed to devices including components for performing at least some of the aspects and features of the described methods, be it by way of hardware components, software or any combination of the two, or in any other manner. Moreover, an article of manufacture for use with the apparatus, such as a pre-recorded storage device or other similar non-transitory computer readable medium including program instructions recorded thereon, or a computer data signal carrying computer readable program instructions, may direct an apparatus to facilitate the practice of the described systems and methods. It is understood that such apparatus, articles of manufacture, and computer data signals also come within the scope of the present example embodiments.

While some of the above examples have been described as occurring in a particular order, it will be appreciated by persons skilled in the art that some of the messages or events or steps or processes may be performed in a different order provided that the result of the changed order of any given step will not prevent or impair the occurrence of subsequent steps. Furthermore, some of the messages or steps described above may be removed or combined in other embodiments, and some of the messages or steps described above may be separated into a number of sub-messages or sub-steps in other embodiments. Even further, some or all of the steps of the conversations may be repeated, as necessary. Elements described as methods or steps similarly apply to systems or subcomponents, and vice-versa. Reference to such words as “sending” or “receiving” could be interchanged depending on the perspective of the particular device.

The term “computer readable medium” as used herein includes any medium which can store instructions, program steps, or the like, for use by or execution by a computer or other computing device including, but not limited to: magnetic media, such as a diskette, a disk drive, a magnetic drum, a magneto-optical disk, a magnetic tape, a magnetic core memory, or the like; electronic storage, such as a random access memory (RAM) of any type including static RAM, dynamic RAM, synchronous dynamic RAM (SDRAM), a read-only memory (ROM), a programmable-read-only memory of any type including PROM, EPROM, EEPROM, FLASH, EAROM, a so-called “solid state disk”, other electronic storage of any type including a charge-coupled device (CCD), or magnetic bubble memory, a portable electronic data-carrying card of any type including compact flash, secure digital (SD-CARD), memory stick, and the like; and optical media such as a Compact Disc (CD), Digital Versatile Disc (DVD) or Blu-ray™ Disc.

Variations may be made to some example embodiments, which may include combinations and sub-combinations of any of the above. The various embodiments presented above are merely examples and are in no way meant to limit the scope of this disclosure. Variations of the innovations described herein will be apparent to persons of ordinary skill in the art having the benefit of the present disclosure, such variations being within the intended scope of the present disclosure. In particular, features from one or more of the above-described embodiments may be selected to create alternative embodiments comprised of a sub-combination of features which may not be explicitly described above. In addition, features from one or more of the above-described embodiments may be selected and combined to create alternative embodiments comprised of a combination of features which may not be explicitly described above. Features suitable for such combinations and sub-combinations would be readily apparent to persons skilled in the art upon review of the present disclosure as a whole. The subject matter described herein intends to cover and embrace all suitable changes in technology.

What is claimed is:

1. A method of controlling a media component over a network, the method executed on a processor and comprising:
receiving an instruction over the network from a controller;
in response to receiving the instruction, transmitting an acknowledgment over the network to the controller; and
executing an operation on the media component, the operation being identified in the instruction.

2. The method of claim 1, wherein the acknowledgement comprises one of a confirmation that the instruction was received and a verification that operation was executed.

3. The method of claim 1, wherein the media component comprises one or more of a cable box, a PVR, a DVD, an audio emitter, and a video display.

4. The method of claim 1, wherein the network is the Internet.

5. The method of claim 1, wherein the operation is executed using one or more of an infrared transceiver that is optically coupled to the media component being controlled, an RS232 serial interface that is electrically connected to the media component being controlled, and an Ethernet interface that is electrically connected to the media component being controlled.

6. The method of claim 1, further comprising, before receiving the instruction, receiving an invitation to communicate with the controller.

7. The method of claim 6, wherein the invitation comprises a spoken invitation transmitted over Voice over Internet Protocol (VoIP) to communicate with the controller using VoIP.

8. The method of claim 7, wherein an operation of the media component is interrupted for the duration of the incoming invitation.

9. The method of claim 8, wherein the media component comprises an audio speaker, and wherein the interruption comprises automatically lowering the volume of audio emitted from the audio speaker for the duration of the interruption.

10. The method of claim 1, wherein the instruction comprises an instruction to present a media application and wherein the operation comprises presenting the media application, the method further comprising:
initiating a copy of the media application for presentation on a controller user interface, the controller user interface being associated with the controller;
initiating the media application for presentation on a user interface of the media component; and,
synchronizing the presentation of the media application on the user interface of the media component with the presentation of the copy of the media application on the controller user interface.

11. The method of claim 10, wherein the user interface of the media component comprises a display screen.

12. A system for controlling a media component, the system comprising:
a controller; and,
a media computer for communicating with the controller over a network, the media computer connected to the media component for executing operations on the media component, the media computer comprising a memory with instructions stored thereon and a processor for executing instructions.

13. The system of claim 12, wherein the media computer further comprises one or more interfaces to the media component and wherein the one or more interfaces comprises Consumer Electronics Control (CEC), Universal Serial Bus (USB), RS232. Ethernet, Bluetooth or an infrared emitter.

14. The system of claim 12 wherein the network is the Internet.

15. The system of claim 12, further comprising an infrared transceiver connected to the media component and in communication with the media computer, the infrared transceiver for receiving instructions from the media computer and mapping the instructions to an infrared signal for sending to the media component.

16. The system of claim 12, further comprising a controller interface, and wherein the controller is configured to synchronize the presentation of a duplicate version of a media application on the controller user interface and the presentation of the media application by the media computer on a user interface of the media component.

17. The system of claim 16, wherein the controller and media computer are configured to transmit communications over the network while the media application and duplicate media application are presented in synchronicity.

18. The system of claim 17, wherein the communications comprise VoIP.

19. A computer readable medium comprising processor-executable instructions which, when executed, cause a processor to:
receive an instruction over a network from a controller;
in response to receiving the instruction, transmit an acknowledgment over the network to the controller; and
execute an operation on a media component, the operation being identified in the instruction.

20. The computer readable medium of claim 19, wherein the instruction comprises an instruction to present a media application, wherein the operation comprises presenting the media application on a user interface of the media component, and wherein the processor is further configured to:
synchronize the presentation of the media application on the interface of the media component with the presentation of a duplicate of the media application on a controller interface associated with the controller.
